(19) United States
(12) Patent Application Publication
(10) Pub. No.: US 2010/0215438 A1
(43) Pub. Date: Aug. 26, 2010

(54) PIPE PULLING DEVICE AND METHODS

(76) Inventors: Wesley E. White, Bountiful, UT (US); Kirk Gough, Bountiful, UT (US)

Correspondence Address: HOLLAND & HART, 222 South Main Street, Suite 2200, P.O. Box 11583, Salt Lake City, UT, 84101, US

(21) Appl. No.: 12/392,024

(22) Filed: Feb. 24, 2009

(51) Int. Cl. F16L 55/18

(52) U.S. Cl. 405/184.1; 242/390

(57) ABSTRACT

A pipe pulling device and related methods for removal of an existing old length of pipe and replacement of the old pipe with a length of new, replacement pipe. The pipe pulling device includes a housing, a drive assembly mounted to the housing, and a spool assembly mounted to the housing and operably coupled to the drive assembly. The pipe pulling device can also include a cable attachment mechanism that secures a cable that extends through the old pipe to the spool assembly. The drive assembly operates to rotate a portion of the spool assembly thereby wrapping the old pipe and cable about the spool assembly. An end of the new, replacement pipe can be secured to an opposite end of the cable, wherein the new, replacement pipe is drawn into a cavity vacated by the old pipe as the old pipe is being withdrawn and wrapped about the spool assembly.

### TECHNICAL FIELD

The present disclosure is directed to devices and methods for replacement of underground pipe.

### BACKGROUND

A variety of systems are known for the installation and replacement of underground pipes. One method for replacing existing underground pipe with replacement pipe is to excavate the entire length of the existing pipe, remove the old pipe and place a new replacement pipe in the excavation. Excavation of existing pipe is time-consuming, labor intensive and can result in significant damage to the area surrounding the excavation. For example, in many instances the pipe is buried beneath buildings, streets and other structures such that the excavating can result in costly damage to the surrounding structures. Excavation can also be complicated by the presence of underground utilities such as gas lines, cables, and power lines.

Directional boring apparatuses for making holes through soil are well-known and are used to replace existing pipes in some circumstances. A directional borer generally includes a series of drill rods joined end-to-end to form a drill string. The drill string is pushed or pulled through the soil by means of powerful hydraulic device such as a hydraulic cylinder. A spade, bit or drill head configured for boring is disposed at the end of the drill stream and may include an injection nozzle for injecting wire to assist in boring. After the bore is complete, a replacement pipe can be drawn through the bore.

Alternative devices and methods exist for pulling an existing pipe that is buried while concurrently pulling a new pipe into the cavity or bore vacated by the removed pipe. Such pipe pulling methods typically require minimal excavation along the length of the pipe that is being removed. In some instances, the forces involved in the pipe-pulling operation result in the device breaking while lodged in the ground. In such situations, the existing underground pipe is blocked and damaged and the only remedy is to retrieve the device by excavation.

In one method, a pneumatic impact boring tool is sent through the existing pipeline such that the head of the tool, which may be provided with blades that apply intense local pressure to the existing pipe, fractures or splits the existing pipe. The replacement pipe, typically made of plastic, can be drawn along behind the boring tool. Pneumatic impact boring tools require an air compressor. Exhaust from the impact tool is typically vented into the interior of the replacement pipe, which is unacceptable for certain types of pipe installation such as gas and water lines. Pneumatic impact boring tools are often less effective on duct tile or non-frangible pipes such as copper, lead and certain types of plastic.

In another example method, a cable is attached to the front end of the pipe being removed and the cable is threaded through the existing pipeline. An opposing end of the cable can be attached to the replacement pipe. The cable is then attached to a backhoe or other vehicle that applies a pulling force on the cable and pipes. Such a method can be less desirable for several reasons. First, the amount of force required to “break loose” the old pipe is typically relatively high and cannot reliably be applied by the backhoe or vehicle. Second, driving a backhoe or other vehicle with the cable and pipes attached can cause disruptions to traffic flow when working near a street. Third, it is often difficult to apply a consistent pull force using a backhoe or other vehicle that is appropriate for the type, size (including length) of the pipes being removed and the new pipe being installed. Fourth, there are often safety concerns when dealing with a long-length of cable and pipe exposed out-of-ground where a significant tension force is being applied.

Thus, opportunities exist for advancement in this technical field.

### SUMMARY

The present disclosure is directed to a pipe pulling device and related methods for removal of an existing old length of pipe and replacement of the old pipe with a length of new, replacement pipe. In one example, a pipe-pulling device includes a housing, a drive assembly mounted to the housing, a spool assembly mounted to the housing and operably coupled to the drive assembly, and a pipe-attachment mechanism that is secured to an end of the old pipe and a cable that extends through the old pipe. The drive assembly operates to rotate a portion of the spool assembly thereby wrapping the old pipe and cable about the spool assembly.

Another aspect of the present disclosure is directed to a method of removing a buried length of old pipe using a pipe removal system. The pipe removal system includes a housing, a drive assembly mounted to the housing, and a spool assembly mounting to the housing and operably coupled to the drive assembly. The method can include passing a cable through the buried pipe, coupling a free end of the cable to the spool assembly, coupling a free end to the old pipe to the spool assembly, and rotating the spool assembly with a drive assembly to wrap the cable and old pipe about a portion of the spool assembly thereby removing the buried length of old pipe. Further steps the example method can include digging a hole adjacent to the free end of the old pipe, positioning the pipe removal system in the hole, and drawing the cable and old pipe laterally into the housing. Another aspect of the example method can include securing a length of new pipe to the cable at the end of the cable opposite the free end, wherein rotating the spool assembly with the drive assembly includes simultaneously pulling the length of new pipe into a pipe cavity in the ground vacated by the old pipe as the cable and old pipe are wound about the spool assembly.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

FIG. 1 is a exploded perspective view of an example pipe pulling device in accordance with principles of the present disclosure.

FIG. 2 is a schematic front perspective view of the example device shown in FIG. 1.

FIG. 3 is a schematic rear view of the example device shown in FIG. 1.

FIG. 4 is a schematic right-side perspective view of the device shown in FIG. 1.

FIG. 5 is a schematic left-side perspective view of the device shown in FIG. 1.

FIG. 6 is a schematic front plan view of another example pipe pulling device in accordance with principles of the present disclosure.

FIG. 7 is a schematic rear plan view of the device shown in FIG. 6.

FIG. 8 is a schematic top plan view of the device shown in FIG. 6.

FIG. 9 is a schematic left-side view of the example device shown in FIG. 6.

FIG. 10 is a schematic cross-sectional view of an underground pipe prepared for replacement.

FIG. 11 is a schematic cross-sectional view of the underground pipe shown in FIG. 10 connected to the device shown in FIG. 1.

FIG. 12 is a schematic top view of an example cable attachment mechanism in accordance with principles of the present disclosure.

FIG. 13 is a partial exploded view of the cable attachment mechanism of FIG. 12.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

All buildings supplied with water or natural gas or connected to the main (the pipeline that supplies gas or water to the general area) by a small diameter pipe known as a service connection. It is common to replace the service connection due to deterioration over time or due to a poor choice of pipe materials at some time in the past.

In water lines, leaks may occur or loss of flow due to calcium or mineral deposits built up in the water lines. For house connections in many countries, these older water or gas pipelines are typically made of plastic or copper for gas supply and water lines can be plastic, copper, galvanized steel, and sometimes lead. Lead pipes are especially of concern to health and the environment and typically need to be removed. The pipes connecting the main to a residential home are usually smaller in diameter than the main. For plastic gas pipe, the inside diameter may be as small as, for example, 0.38 inches. Often, the pipe replacing the old line will be the same size or slightly larger.

The present disclosure is directed to devices and methods for replacing existing pipeline with a new pipeline without having to dig a trench line the entire or substantially the entire length of the pipeline. The examples described herein are typically capable of simultaneously enlarging the existing bore hole defined by the removed pipeline while pulling the new pipeline into place.

The examples disclosed herein can be particular useful for replacement of relatively short lengths of pipe such as, for example, in the range of about 10 feet to about 100 feet, and more preferably in the range of about 20 feet to about 60 feet. However, other lengths of pipe can also replaced using the examples disclosed therein. For example, replacing pipe lengths of less than 10 feet (i.e., a length of pipe that extends underneath a sidewalk structure) could be easily handled by the example devices and methods disclosed herein. Likewise, replacing lengths of pipe greater than 100 feet (i.e., lengths of pipe in the range of 100 feet to about 300 feet) is possible depending on, for example, the diameter and material of the pipe being replaced as well as the diameter and material of the new pipe, and taking into consideration other factors such as the type of soil, the compaction of the soil and other environmental factors.

Typically, the example devices and methods described herein include the need to dig a hole at opposing ends of the pipe that is being replaced. The pipe pulling device is positioned in one hole and preferably arranged for application of a lateral force to the pipe being replaced in a direction along a longitudinal axis of the pipe being replaced. The new pipe is inserted into the bore hole left as the old pipe is being removed via the hole dug at the opposite end of the pipe being replaced. In some instances, one of the holes at one end of the pipe being replaced is adjacent to the main line to which the service connection line is attached. In many instances, the main line is buried beneath a structure such as a road, sidewalk, driveway. In such instances, the pipe pulling device can be particularly useful because the hole that is dug that exposes the main line and the one end of the pipe being replaced can be minimized (i.e., sized only large enough to accommodate the pipe pulling device) without further damage to the surrounding structure (i.e., the road, sidewalk, driveway, etc.).

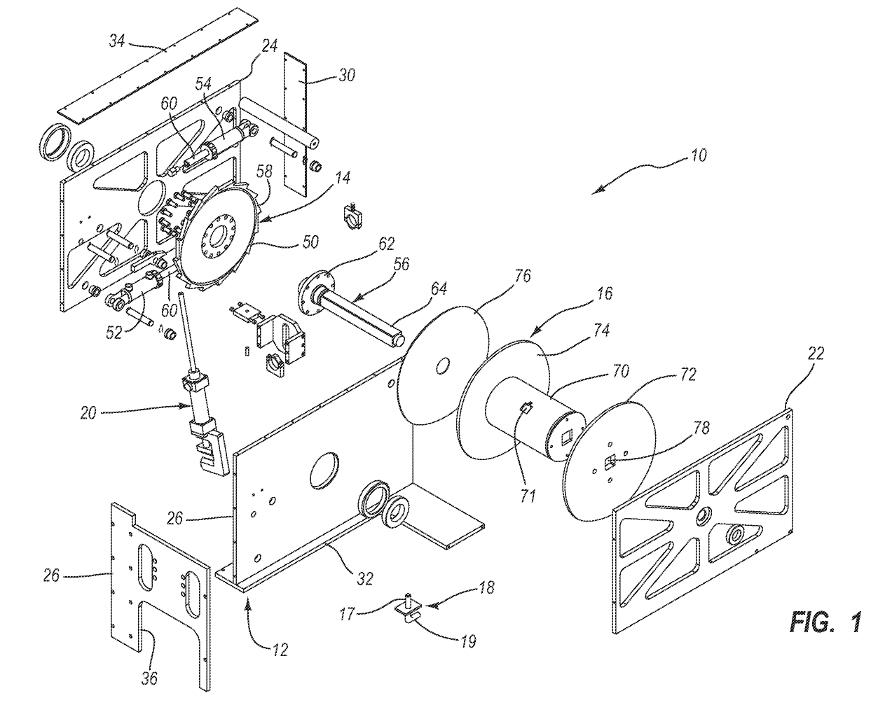

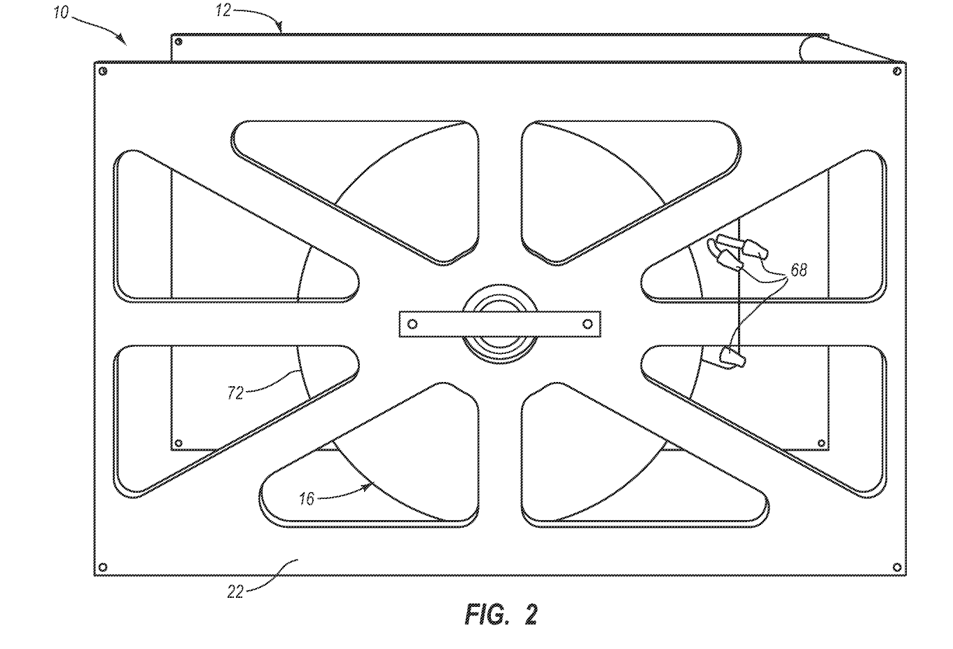

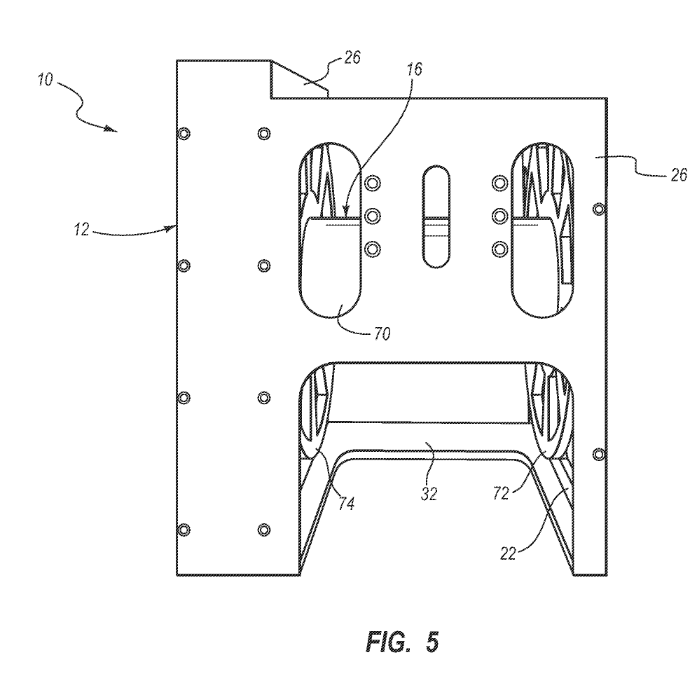

Referring now to FIGS. 1-5, an example pipe pulling device 10 is shown and described. The device 10 includes a housing assembly 12, a drive assembly 14, a spool assembly 16, and a distal cable attachment mechanism 18. FIG. 1 is an exploded perspective view of pipe pull device 10. FIGS. 2-5 are front, rear, right side, left side view, respectively, of device 10.

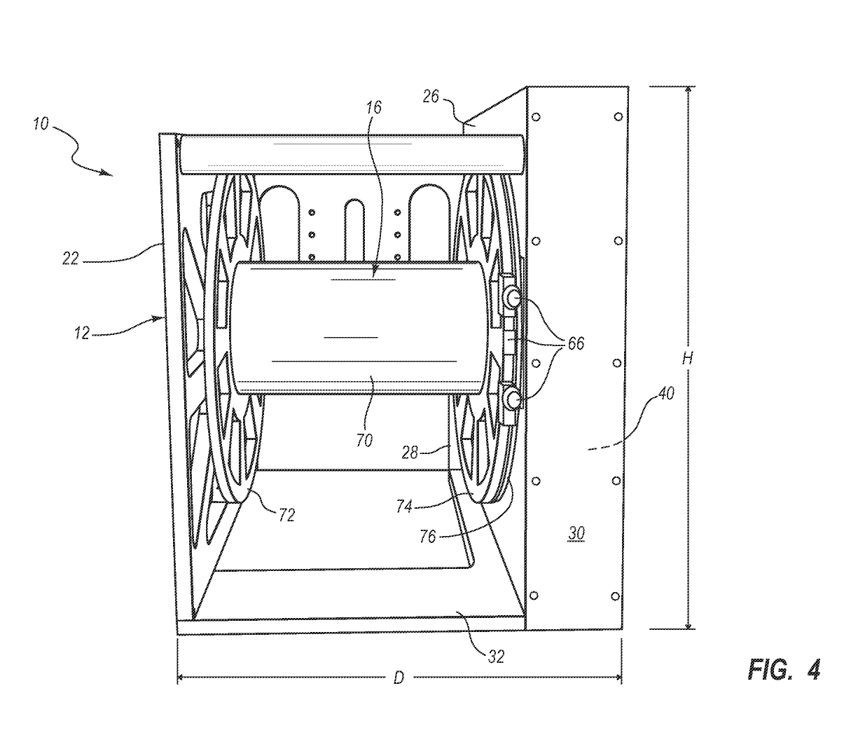

The housing assembly 12 includes a front panel 22, a rear panel 24, a center panel 26 space between the front and rear panels 22, 24, a thrust panel 28 (also referred to as a front panel 28), a side cover panel 30 (also referred to as a rear panel 30), a base panel 32, and a top panel 34. When assembled, the housing assembly 12 defines a spool housing portion 38 defined generally as the space between the front and center panels 22, 26, and a drive housing portion 40 defined generally between the center and rear panels 26, 24 (see FIG. 4). Components of the drive assembly 14 are primarily positioned within the drive housing portion 40. The spool assembly 16 is positioned primarily within the spool housing portion 38.

The thrust panel 28 includes a pipe opening 36. The pipe opening 36 is sized to permit a length of pipe and/or cable to pass there-through and be wound upon the spool assembly 16. Typically, the pipe pulling device 10 is arranged with the thrust panel 28 oriented facing a generally vertical ground surface through which the old pipe as being replaced extends into a excavated hole within which the pipe pulling device 10 is positioned. The pipe opening 36 is arranged such that the pipe pulling device 10 can apply a laterally-directed force along a longitudal axis of the old pipe to draw the old pipe into the housing assembly 12 and be wound about the spool assembly 16, as will be described in further detail below. Other configurations for the housing panels are possible in alternative arrangements.

The housing assembly 12 can comprise any desired material that provides preferred strength and durability characteristics. In one example, materials of the housing assembly 12 are selected to minimize the weight of the pipe pulling device 10. In one example, at least some of the housing assembly 12 comprises an aluminum material, a polymeric material or a composite material. One or more of the panels 22, 24, 26, 28, 30, 32, 34 of the housing assembly 12 can have portions thereof that are removed to minimize the weight while maintaining structural integrity of the panel.

One object of the design of housing assembly 12 can be to reduce the weight of the pipe pulling device 10 sufficiently to permit the device 10 to be carried and otherwise handled by only one or two operators. The size, shape and number of components as well as the material composition of various features of the housing assembly 12 can influence the total weight of pipe pulling device 10.

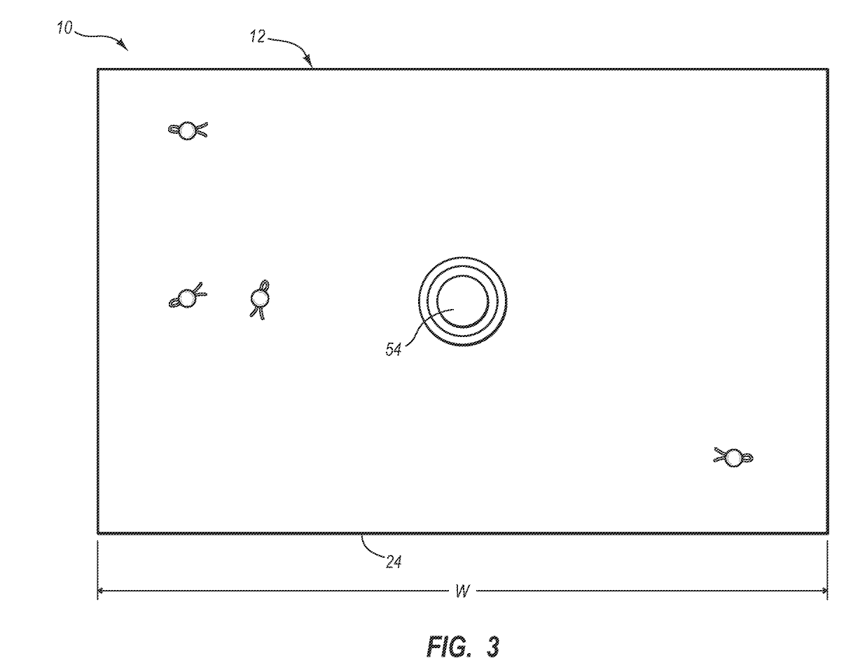

In one example, the height H, width W, and depth D of the housing assembly 12 (see FIGS. 3 and 4) are sized to permit the pipe pulling device 10 to fit within an excavated hole having dimensions no greater than about 4 ft.×4 ft.×4 ft. Another example, the width W can be in the range of about 2 ft. to about 5 ft., the height H in the range of about 1 ft. to about 4 ft., and the depth D in the range of about 1 ft. to about 3 ft. Many other shapes and sizes for the housing assembly 12 are possible in addition to those illustrated in the figures and described above.

The drive assembly 14 includes a ratchet plate 50, first and second ram assemblies 52, 54, and a drive shaft 56. The ratchet place 50 includes a pair of drive surfaces 58 configured and arranged for engagement by an engagement end 60 of each of the first and second ram assemblies 52, 54. First and second ram assemblies 52, 54 are operable between retracted and extended configurations. In the retracted configuration, the engagement end 60 is typically removed from engagement with the drive surfaces 58. In the extended configuration, the engagement end 60 engages one of the drive surfaces 58 to rotate the ratchet plate 50.

The drive shaft 56 includes first and second end portion 62, 64. The first end portion 62 is coupled to the ratchet plate 50. The second end portion 64 is coupled to the spool assembly 16. The drive shaft 56 is arranged such that the drive shaft 56 rotated concurrently and at the same rate of rotation as the ratchet plate 50. Drive shaft 56 is also arranged such that the spool assembly 16 rotates concurrently and at the same rotation rate as the drive shaft 56 and the ratchet plate 50. In other arrangements, one or more gear assemblies can be interposed between the ratchet plate 50 and drive shaft 56 or between the drive shaft 56 and spool assembly 16. Such gear assemblies either increase or decrease a gear ratio between the ratchet plate 50 and spool assembly 16.

The first and second ram assemblies 52, 54 can operate in unison between extended and retracted configurations. Alternatively, the first and second ram assemblies 52, 54 can operate in succession such that the first ram assembly is in an extended configuration while the second ram assembly is in a retracted configuration, with the ran assemblies 52, 54 alternating between such extended and retracted configurations. In yet further embodiments, the first and second ram assemblies 52, 54 can alternate between concurrent and successive operations. For example, when a greater amount of torque is needed (i.e., to apply a “break loose” force to the pipe being removed), the first and second ram assemblies can operate concurrently to apply a rotation force to the ratchet plate 50 at the same time. However, after the old pipe has been broken free, the operation of the ram assemblies 52, 54 can be switched to successive operation wherein less torque is required to maintain movement of the old pipe and/or drawing in of the replacement pipe.

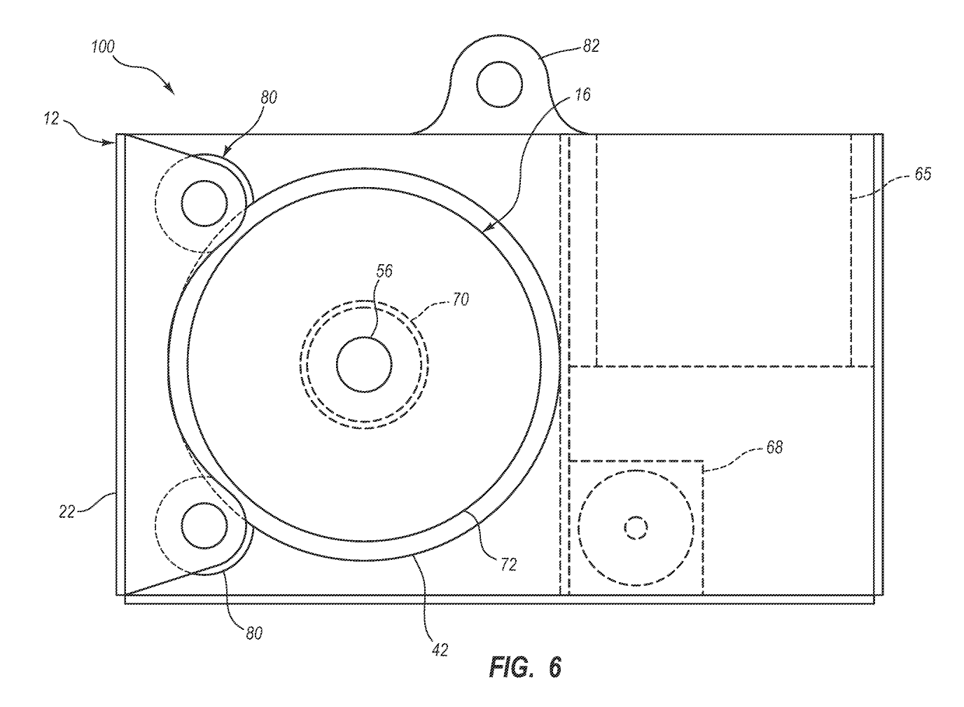

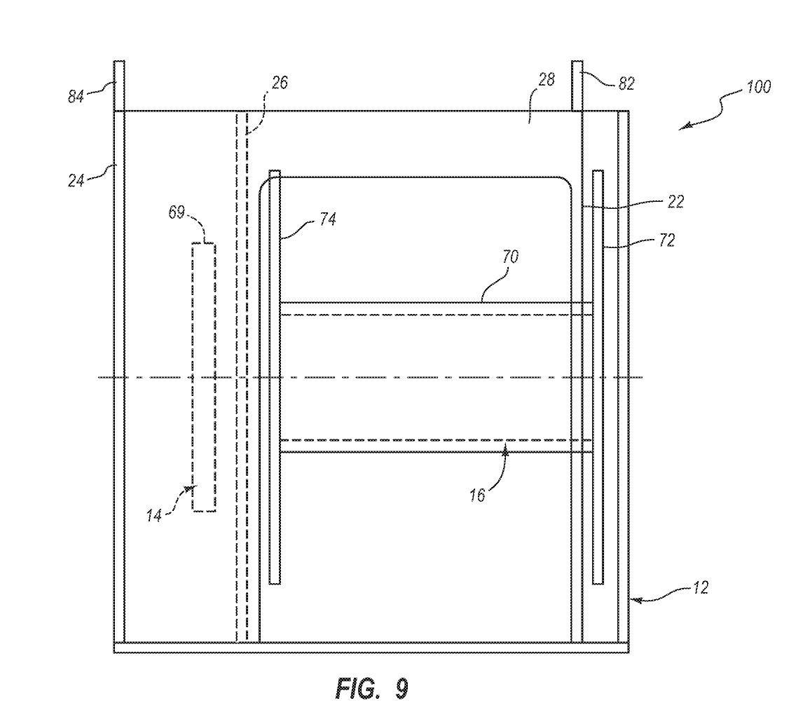

The drive assembly 14 includes two ram assemblies 52, 54. In other arrangements, a single ram assembly can be used for rotation of the ratchet plate 50. In still further arrangements, more than two ram assemblies can be used for rotation of the ratchet plate. Further, different power sources can be used for rotation of the ratchet plate or a similar structure that is used for rotation of the drive shaft 56. For example, the drive shaft 56 can be coupled to an output shaft of an engine or motor that is positioned adjacent to or mounted within the housing assembly 12. In other arrangements, chains, sprockets, pulleys, belts and other drive features can be used to rotate the drive shaft 56. One example of a chain- or belt-driven pipe pulling device is described herein with reference to FIGS. 6-11.

The first and second ram assemblies 52, 54 can be coupled to a hydraulic power supply via one or more hydraulic supply lines 66. The hydraulic power source can be mounted directly to the housing assembly 12. Alternatively, the hydraulic power source can be located remote from the housing assembly 12, such as, for example, in combination with a generator that is located outside of the excavated hole within which the pipe pulling device 10 is located.

The spool assembly 16 includes a spool drum 70, a front drum plate 72, a rear drum plate 74, a rear plate 76, and a drive shaft aperture 78. The spool drum 70 is configured and arranged within the housing assembly 12 to provide winding up of the old pipe and cable as the old pipe and cable are pulled out of the ground and the replacement pipe is drawn into the cavity vacated by the old pipe. The wear plate 76 can be positioned between the rear drum plate 74 and the center panel 26 to help minimize wear of the rear drum plate 74.

The drive shaft aperture 78 can be shaped and sized to receive the second portion 64 of the drive shaft 56. The drive shaft aperture 78 is shown in FIG. 1 having a rectangular shape that is sized substantially identically to the rectangular outer profile of the second portion 64 the drive shaft 56. Other shapes and sizes for both the drive shaft aperture 78 and the second portion 64 of the drive shaft 56 are possible. Preferably, the drive shaft 56 and drive shaft aperture 78 are configured to promote transfer of rotational forces from the drive shaft 56 to the spool drum 70. In some arrangements, bearings, shear pins, key members, or other structures can be used to provide a drive connection between the drive shaft 56 and the spool drum 70.

The spool assembly 16 can comprise other embodiments for the spool drum 70 without use of the front, rear, or wear plates 72, 74, 76. In other arrangements, the spool assembly 16 comprises only the second portion 64 of the drive shaft 56 without the addition of at least the spool drum 70. In such an arrangement, the old pipe and cable can be wrapped directly onto the drive shaft 56.

The spool assembly 16 can be accessed by removing the front panel 22 of the housing assembly 12. Removal of the front panel 22 permits the spool assembly 16 to be slid off of the drive shaft 56. Alternatively, the front drum plate 72 can be disengaged from the spool drum 70 to permit removal of the wound-up old pipe and cable that have collected on the spool drum 70 while the remaining portions of the spool assembly stay mounted to the drive assembly 14.

The distal cable attachment mechanism 18 shown in FIG. 1 is configured for attachment to a free end of the cable that extends through the pipe being withdrawn by the pipe pulling device. The distal cable attachment mechanism 18 can include insert features 19 for attachment of the cable attachment mechanism 18 in an aperture or keyway 71 of the spool assembly 16. In one arrangement, the distal cable attachment mechanism 18 can include a protrusion such as a post 17. The post 17 can be used to secure a loop formed in a distal end of the cable. The distal cable attachment mechanism 18 can be removed from the aperture 71 of the spool assembly 16 after the cable and portions of the pipe have been wound around the spool drum 70 at least one wrap.

The cable can be secured to the spool assembly 16 using different attachment configurations. For example, a distal end of the cable can be coupled to a length of chain that is releasably mounted in the aperture 71 of the spool drum 70. In some arrangements, the distal cable attachment mechanism 18 can be configured for attachment to both the old pipe being replaced as well as to the cable. Typically, once the old pipe begins to be wrapped around the spool assembly 16, the pulling forces applied by the device 10 are primarily applied directly to both the cable and that distal end of the old pipe.

The pipe pulling device can include a crimping assembly 20. The crimping assembly 20 can be used to crimp or otherwise secure features to the cable that facilitate removal of the old pipe and replacement of the old pipe with a new length of pipe. The crimping assembly 20 can also be used, for example, to secure a button feature to the cable, wherein the button feature is used to help secure the cable to an attachment device. The crimping assembly 20 can be used to secure portions of the cable together to provide a loop structure at one end of the cable.

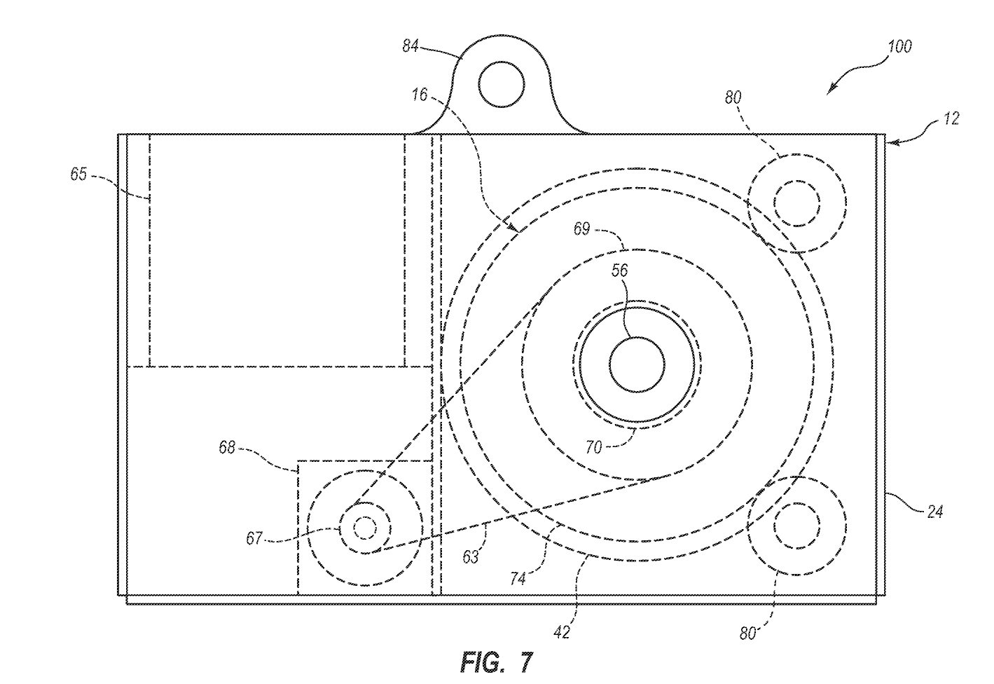

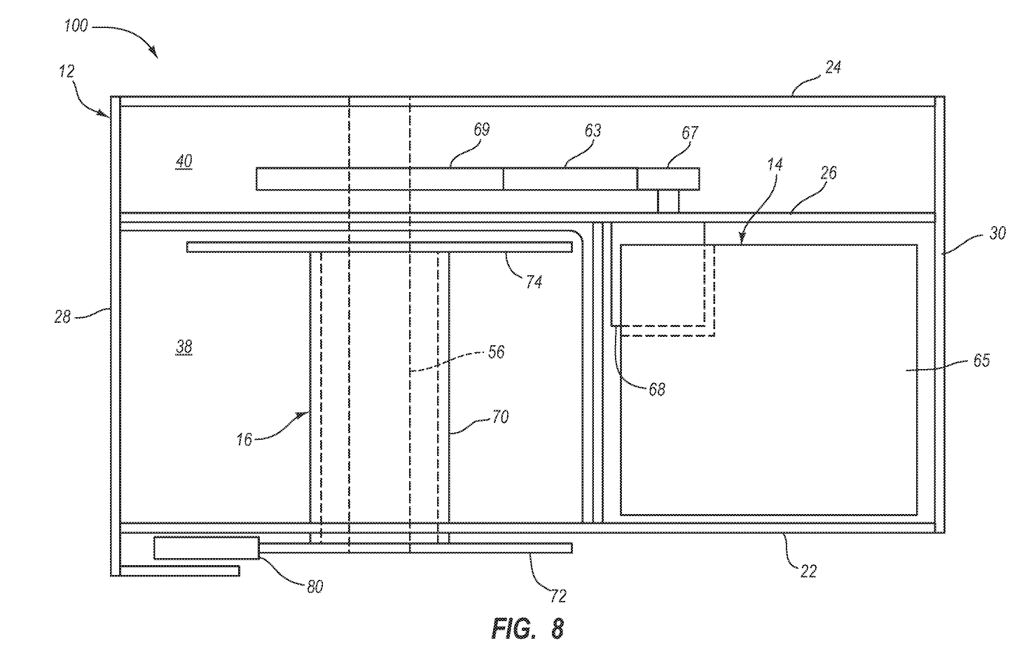

Referring now to FIGS. 6-9, an alternative pipe pulling device 100 is described. The device 100 can include many of the same or similar features as discussed above related to the pipe pulling device 10. For example, the pipe pulling device 100 includes a housing assembly 12, a drive assembly 14, and a spool assembly 16. The housing assembly 12 includes front, rear and center panels 22, 24, 26 in addition to thrust and side panels 28, 30, respectively. The panels 22, 24, 26, 28, 30 define spool and drive housing portions 38, 40 (see FIG. 8).

The drive assembly 14 includes an engine 65 and hydraulic motor 68 to drive the spool assembly 16 via a drive sprocket 67 and a spool sprocket 69 that are interlinked with a chain or belt 63. Inclusion of the engine 65 and hydraulic motor 68 provides the pipe pulling device 100 with a self-contained power source for operation of and driving of the spool assembly 16. In one example, the engine 65 is a Briggs & Stratton 5 horsepower gas engine. Many other types of engines having different power ratings can be used. The engine 65 can be positioned within the housing assembly 12. Alternatively, the engine 65 can be positioned mounted on a top or side surface of the housing assembly 12 exterior of the housing assembly 12. In some arrangements, the pipe pulling device 100 is operable without the hydraulic motor 68. For example, the drive sprocket 67 can be driven directly by the engine 65.

The drive and spool sprockets 67, 69, respectively, can provide an appropriate gear ratio that delivers the necessary torque needed to overcome the “break loose” force for removing the old pipe being replaced. Additional gears, sprockets, and driving members such as chains or belts can be used to provide one or more gear ratios appropriate for different stages of operation of the pipe pulling device 100.

The front panel 12 can be configured with a spool aperture 42 sized for portions of the spool assembly 16 to be removed there through. The spool assembly 16 can include at least one pressure wheel 80 arranged in contact with the front drum plate 72 to help retain the spool assembly 16 in a predetermined axial and radial position relative to the housing assembly 12 during operation of pipe pulling device 100. At such point the spool assembly 16 is to be removed from the housing assembly 12, the pressure wheels 80 can be released from applying an radially inward directed force on the front drum plate 72. The assembly of spool drum 70 with front and rear drum plates 72, 74 can be slid off of the drive shaft 56 and removed from the housing assembly 12. Alternatively, only the front drum plate 72 is removed to provide access to the wound up cable and old pipe. The use of pressure wheels 80 or similar structure can provide a quick release arrangement for easily removal of the spool assembly 16. In some arrangements, the spool assembly 16 is configured for removal from the housing assembly 12 without the use of tools such as wrenches or sockets. In one example, removal of a quick-release pin from an end of the drive shaft 56 can release the spool assembly 16 or portions of spool assembly 16 for easy dismounting from the drive shaft 56.

The pipe pulling device 100 can further include a pair of lifting connectors 82, 84. The lifting connectors 82, 84 may be used to connect to a chain, cable, rod or other device that is used to help maneuver the pipe pulling device 100 into position. The lifting connectors 82, 84 can be positioned along a top surface of the pipe pulling device 100 to provide easier access. Alternatively, the lifting connectors 82, 84 can be positioned at other locations on the pipe pulling device such as along one of the side or end surfaces.

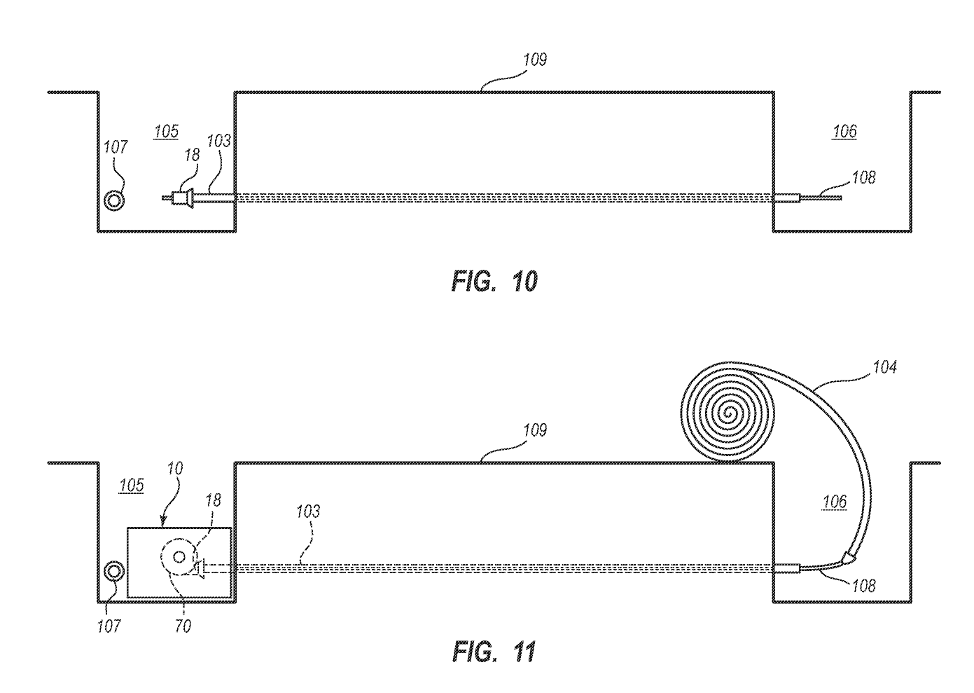

Referring now to FIGS. 10 and 11, example methods of removing an old buried pipe and replacing the old pipe with a new replacement pipe is discussed. FIG. 10 illustrates an old pipe 103 buried below a ground surface 109. Holes 105 to 106 are excavated at opposing ends of the old pipe 103. In some instances, a main pipe 107 is exposed within the hole 105. The new pipe, after being drawn into position replacing the old pipe 103, can be connected to the main line 107. A cable 108 is advanced through the old pipe 103. A cable attachment mechanism 18 is mounted to a free end of the old pipe 103 and to the cable 108 within the hole 105.

Referring now to FIG. 11, the pipe pulling device 10 is positioned within the hole 105 and the cable attachment mechanism 18 is mounted to the spool assembly 16 of the pipe pulling device 10. Various ways of attaching the cable attachment mechanism 18 to the spool assembly 16 can be employed. For example, a key slot or aperture 71 defined in the spool assembly 16 and a key member such as the distal cable attachment member 18 can provide the desired connection (see FIG. 1).

An opposite or proximal end of the cable 108 can be operatively connected to a proximal end of the old pipe 103 within the hole 106. By operatively connecting the cable 108 to the proximal end of the old pipe 103, pulling on the cable in the distal direction using the pipe pulling device 10 can apply a pushing force in the distal direction applied at the proximal end of the old pipe 103. This pushing force facilitates removal of the old pipe 103 even if the old pipe 103 breaks or has defects along its length prior to or during winding of the old pipe 103 about the spool assembly 16.

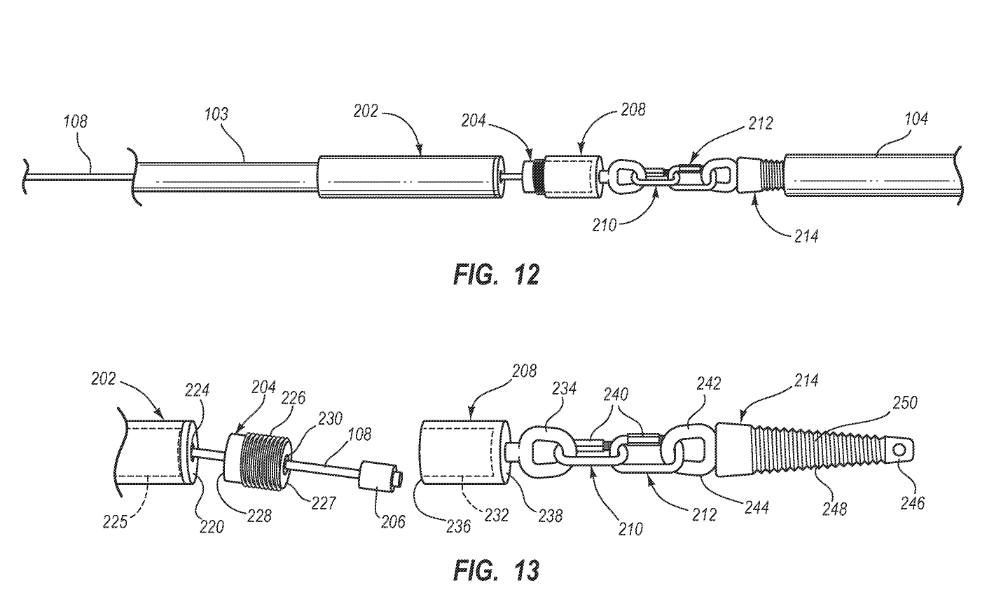

FIGS. 12 and 13 illustrate an example pipe connection assembly 200 for use in connecting the cable 108 to a proximal end of the old pipe 103 and a distal end of the new pipe 104. The pipe connection assembly 200 includes a sleeve 202, a stop member 204, a button 206, a stop connector 208, first and second ring connectors 210, 212, and a new pipe connector 214. The sleeve 202 defines a pipe cavity 225 that is sized to receive the proximal end of the old pipe 103. The sleeve 202 includes a proximal end surface 220 that defines a cable aperture 224 sized for the cable 108 to pass there through. The stop member 204 includes a plurality of threads 226 positioned on an outer surface that are configured for threaded engagement with the stop connector 208. The stop member 204 also includes a distal end 228, a proximal end 227, and a cable aperture 230 defined in the proximal end 227. The distal end 228 is arranged to abut against the proximal end surface 220 of the sleeve 202. The cable aperture 230 is sized to permit the cable 108 to pass there through, but is small enough that the button 206 cannot pass there through. The button 206 is mounted to the cable 108 using, for example, crimping, pressing, threaded engagement, or other attachment methods. In one example, the button 206 is mounted to the cable 108 using the crimping assembly 20.

The stop connector 208 includes a threaded aperture 232 accessible from a distal end 236, and a loop 234 positioned at a proximal end 238. The threaded aperture 232 is configured to threadably mate with the threads 226 of the stop member 204. The loop 234 may be used to secure the cable 108 to the new pipe 104. In operations that require only removing the old pipe 103 and not concurrent replacement of the old pipe 103 with a new pipe 104, the sleeve 202, stop 204, and button 206 can be used without other features of the pipe connection assembly 200.

The stop connector 208 can be connected directly to the new pipe connector 214. Alternatively, the stop connector 208 can be connected to the new pipe connector 214 using a plurality of ring connectors, such as first and second ring connectors 210, 212. Each of the first and second ring connectors 210, 212 can include an access member 240 that provides opening and closing of the ring connectors 210, 212.

The new pipe connector 214 includes a loop 242 extending from a distal end 244, and a tapered portion 248 positioned at a proximal end 246. The tapered portion 248 can include a plurality of threads 250 or other connecting features that provide locking engagement between the new pipe connector 214 and an interior surface of the new pipe 104. The tapered portion 248 provides use of the new pipe connector 214 with pipes having different internal dimensions. Other types of new pipe connectors are possible that connect to a new pipe in alternative ways. For example, another new pipe connector configuration may connect to an outer surface of the new pipe, or connect to both an inner and outer surface of the new pipe.

The pipe connection assembly 200 can be used solely to pull a new pipe into a cavity vacated previously by an old length of pipe. When using the pipe connection assembly 200 only for pulling a new length of pipe 104, the stop member 204 and button 206 are positioned at the proximal end of cable 108. The stop connector 208 is secured to the stop member 204 and coupled to the new pipe connector 214 (with or without the first and second ring connectors 210, 212). The new pipe connector 214 is connected to the new length of pipe 104 prior to or after assembling the pipe connector assembly 200 with the cable 108.

Referring again to FIGS. 10 and 11 and a method of simultaneous removing the old pipe 103 and pulling in a new pipe 104, the pipe pulling device 10 can be activated to begin rotation of the spool assembly 16 thereby winding up a length of the old pipe 103 and cable 108. Concurrently, the new pipe 104 is pulled into a cavity in the ground that is vacated by the old pipe 103 as the old pipe 103 is wound up by the pipe pulling device 10.

Typically, the pipe pulling device 10 provides sufficient pulling power necessary to draw a length of new pipe 104 into the cavity vacated by the old pipe 103, wherein the new pipe 104 has a diameter at least the same or greater than an outer diameter of the old pipe. In one arrangement, the pipe pulling device 10 can remove an old pipe 103 and replace it with a new replacement pipe 104 at a rate of about 2 to about 20 linear feet per minute, and more preferably about 5 to about 15 linear feet per minute.

In some arrangements, the housing assembly 12 can be configured with a pipe splitting device located at an entrance into the housing assembly 12. A pipe splitting device can be used to split or otherwise remove the old pipe from off of the cable 108 as the old pipe is being extracted from the ground. The split old pipe 103 can be recycled in some cases, which may be particularly advantageous when the old pipe comprises copper or other valuable recyclable material. Alternatively, a wound-up roll of cable 108 and old pipe 103 can be removed from the housing assembly 12 and cut along one side of the coil to separate individual wraps of the combined cable and old pipe 103. The operator can then manually remove the cut portions of cable 108 from within the pipe 103 and the old pipe can be recycled.

In a further arrangement, after the old pipe has been extracted and wound up within the housing assembly 12, and the wound-up coil of old pipe and cable can be removed from the housing assembly 12 and positioned outside of the pipe pulling device 10. The cable 108 can then be reconnected to the spool assembly 16 and a pipe splitter can be mounted on the housing assembly 12 where the old pipe is drawn into the pipe pulling device 10. The old pipe 103 is split off of the cable 108 as the cable 108 is wound up.

It is anticipated that the general concepts described herein related to the pipe pulling devices 10, 100, pipe connection assembly 200, and related methods as described with reference to FIGS. 1-13 can be scalable to larger or smaller size devices. Various sized pipe pulling devices in accordance with the principles disclosed herein can be used to only pull and remove old pipe, to pull old pipe and concurrently replace the pulled old pipe with a new length of pipe, and to pull pipe of various materials, diameters and lengths for many different applications.

The preceding description has been provided to enable others skilled in the art to best utilize various aspects of the exemplary embodiments described herein. This exemplary description is not intended to be exhaustive or to be limited to any precise form disclosed. Many modifications and variations are possible without departing from the spirit and scope of the instant disclosure. It is desired that the embodiments described herein be considered in all respects illustrative and not restrictive and that reference be made to the appended claims and their equivalents for determining the scope of the instant disclosure.

We claim:

1. A pipe pulling device, comprising:
a housing sized and configured to be positioned in an excavated hole;
a drive assembly mounted to the housing;
a spool assembly mounted to the housing and operably coupled to the drive assembly; and
wherein the drive assembly operates to rotate a portion of the spool assembly to wrap a free end of a pipe and a length of cable extending within the pipe about the spool assembly while extracting the pipe from a buried location that is accessible in the excavated hole.

2. The pipe pulling device of claim 1, wherein the housing includes a plurality of panel members, the panel members defining a drive housing portion sized to retain at least a portion of the drive assembly, and a spool housing portion sized to retain at least a portion of the spool assembly.

3. The pipe pulling device of claim 2, wherein one of the plurality of panels defines a pipe opening, the pipe opening being arranged to draw the pipe laterally into the spool housing portion.

4. The pipe pulling device of claim 1, wherein the housing defines a pipe opening, the pipe opening being arranged to provide lateral access for insertion of the pipe into the housing.

5. The pipe pulling device of claim 1, wherein the drive assembly includes a ratchet plate and at least fluid driven ram operable to engage the ratchet plate to rotate the ratchet plate.

6. The pipe pulling device of claim 5, wherein the drive assembly includes first and second fluid driven rams, wherein the rams are operable to either simultaneously engage the ratchet plate or to sequentially engage the ratchet plate.

7. The pipe pulling device of claim 1, wherein the drive assembly includes at least first and second gear members and a chain operably coupling the first gear member to the second gear member, the first gear member being mounted to a rotatable output shaft of a power source, and the second gear member being mounted to a drive shaft that is operably connected to the spool assembly.

8. The pipe pulling device of claim 7, wherein the chain is positioned in a first portion of the housing and the spool assembly is positioned in a second portion of the housing that is separated from the first portion by a dividing panel.

9. The pipe pulling device of claim 1, wherein at least a portion of the housing is removable to provide access to the spool assembly, wherein a portion of the spool assembly is removable from the device to remove the wrapped up pipe.

10. The pipe pulling device of claim 1, further comprising a cable attachment mechanism configured to couple a free end of the cable to the spool assembly.

11. The pipe pulling device of claim 1, further comprising a new pipe attachment mechanism that is configured to couple the cable to a free end of a new pipe being pulled into a cavity in the ground that is vacated by the pipe being wrapped about the spool assembly.

12. A pipe pulling device, comprising:
a housing having a spool housing portion and a drive housing portion;
a drive assembly mounted to the housing in the drive housing portion, the drive assembly comprising:
a motor providing a rotational output;
a drive shaft; and
a chain operably coupled between the motor and the drive shaft to transfer the rotational output of the motor to rotational movement of the drive shaft; and
a spool assembly mounted to the housing in the spool housing portion and operably coupled to the drive shaft;
wherein the drive assembly operates to rotate a portion of the spool assembly to wrap a pipe about the spool assembly.

13. A method of removing a buried length of old pipe with a pipe removal system, the pipe removal system including a housing, and a drive assembly mounted to the housing, a spool assembly mounted to the housing and operably coupled to the drive assembly, the method comprising:
passing a cable through the buried pipe;
coupling a free end of the cable to the spool assembly;
coupling a free end of the old pipe to the spool assembly; and
rotating the spool assembly with the drive assembly to wrap the cable and old pipe about a portion of the spool assembly thereby removing the buried length of old pipe.

14. The method of claim 13, further comprising digging a hole adjacent to the free end of the old pipe and positioning the pipe removal system in the hole.

15. The method of claim 13, wherein rotating the spool assembly with the drive assembly to wrap the cable and old pipe about a portion of the spool assembly includes drawing the cable and old pipe laterally into the housing.

16. The method of claim 13, wherein the drive assembly includes a ratchet plate and at least one fluid drive ram, and rotating the spool assembly with the drive assembly includes engaging the ratchet plate with the at least one fluid driven ram to rotate the ratchet plate.

17. The method of claim 13, wherein the drive assembly includes a chain driven gear assembly and a portable motor, wherein rotating the spool assembly with the drive assembly includes rotating the chain driven gear assembly with the portable motor.

18. The method of claim 13, wherein the housing includes a plurality of panel members, the method including removing one of the panel members and removing the wound up old pipe and cable from the spool assembly.

19. The method of claim 13, wherein the housing defines a spool opening, the method including removing a portion of the spool assembly through the spool opening, and then removing the wound up old pipe and cable through the spool opening.

20. The method of claim 13, further comprising securing a length of new pipe to the cable at an end of the cable opposite the free end, wherein rotating the spool assembly with the drive assembly further includes simultaneously pulling the length of new pipe into a pipe cavity in the ground vacated by the old pipe as the cable and old pipe are wound about the spool assembly.
